(19) United States
(12) Patent Application Publication
(10) Pub. No.: US 2018/0201067 A1
(43) Pub. Date: Jul. 19, 2018

(54) TIRE COMPRISING LOW-SULPHUR ELASTOMER MIXTURES

(71) Applicant: COMPAGNIE GENERALE DES ETABLISSEMENTS MICHELIN, Clermont-Ferrand (FR)

(72) Inventors: Jean-Luc GUERBERT-JUBERT, Clermont-Ferrand Cedex 9 (FR); Luc BESTGEN, Clermont-Ferrand Cedex 9 (FR); Didier VASSEUR, Clermont-Ferrand Cedex 9 (FR); Delphine NAYRAT, Clermont-Ferrand Cedex 9 (FR)

(73) Assignee: COMPAGNIE GENERALE DES ETABLISSEMENTS MICHELIN, Clermont-Ferrand (FR)

(21) Appl. No.: 15/742,343

(22) PCT Filed: Jul. 6, 2016
(86) PCT No.: PCT/EP2016/065901

§ 371 Date: Jan. 5, 2018

(30) Foreign Application Priority Data
Jul. 10, 2015 (FR) 1556554

(51) Int. Cl. B60C 1/00; B60C 15/06

(52) U.S. Cl. CPC B60C 1/0041; B60C 15/06; B60C 2001/005; B60C 2015/0664; B60C 2015/065; B60C 2015/066; B60C 2015/0621

(57) ABSTRACT

The reinforcing structure for a tire is in the form of a stratified assembly formed of two layers of reinforcing strips of completely connected cross section, and flattened in shape. According to the method, the strips of each layer are laid side by side in a main direction of laying. The strips of the first layer are spaced apart by a distance that is less than the width of the strips of the second layer and in such a way that the edges of the strips of the first layer overlap the edges of the strips of the second layer. The two layers of strips are separated by a layer of uncoupling rubber.

### CROSS-REFERENCE TO RELATED APPLICATIONS

The present application claims priority to PCT International Patent Application Serial No. PCT/EP2016/065901, filed Jul. 6, 2016 entitled “TYRE COMPRISING LOW-SULPHUR ELASTOMER MIXTURES,” which claims the benefit of FR Patent Application Serial No. 1556554, filed Jul. 10, 2015.

### BACKGROUND OF THE INVENTION

### 1. Field of the Invention

The present disclosure relates to a tire with a radial carcass reinforcement, and more particularly to a tire which is intended to equip vehicles that carry heavy loads and run at sustained speed, such as lorries, tractors, trailers or buses, for example.

### 2. Related Art

In the tires of heavy duty type, the carcass reinforcement is generally anchored on either side in the area of the bead and is surmounted radially by a crown reinforcement made up of at least two layers that are superimposed and formed of threads or cords which are parallel in each layer and crossed from one layer to the next, forming angles of between 10° and 45° with the circumferential direction. The working layers that form the working reinforcement may furthermore be covered with at least one layer, referred to as a protective layer, formed of reinforcing elements which are advantageously metallic and extensible and referred to as elastic reinforcing elements. It may also comprise a layer of metal threads or cords having low extensibility, forming an angle of between 45° and 90° with the circumferential direction, this ply, referred to as the triangulation ply, being located radially between the carcass reinforcement and the first crown ply, referred to as the working ply, which are formed of parallel threads or cords lying at angles not exceeding 45° in terms of absolute value. The triangulation ply forms a triangulated reinforcement with at least the working ply, this reinforcement having little deformation under the various stresses to which it is subjected, the triangulation ply essentially serving to absorb the transverse compressive forces which is the role of all the reinforcing elements in the crown area of the tire.

In the case of tires for “heavy duty” vehicles, just one protective layer is usually present and its protective elements are, in the majority of cases, oriented in the same direction and with the same angle in terms of absolute value as those of the reinforcing elements of the radially outermost and therefore radially adjacent working layer. In the case of construction plant tires intended for running on more or less uneven ground, the presence of two protective layers is advantageous, the reinforcing elements being crossed from one layer to the next and the reinforcing elements of the radially inner protective layer being crossed with the inextensible reinforcing elements of the radially outer working layer adjacent to the radially inner protective layer.

Cords are said to be inextensible when the cords exhibit, under a tensile force equal to 10% of the breaking force, a relative elongation at most equal to 0.2%.

Cords are said to be elastic when the cords exhibit, under a tensile force equal to the breaking load, a relative elongation at least equal to 3% with a maximum tangent modulus of less than 150 GPa.

The circumferential direction of the tire, or longitudinal direction, is the direction that corresponds to the periphery of the tire and is defined by the direction in which the tire runs.

The axis of rotation of the tire is the axis about which it turns in normal use.

A radial or meridian plane is a plane which contains the axis of rotation of the tire.

The circumferential median plane, or equatorial plane, is a plane perpendicular to the axis of rotation of the tire and which divides the tire into two halves.

The transverse or axial direction of the tire is parallel to the axis of rotation of the tire. An axial distance is measured in the axial direction. The expression “axially inside of, respectively axially outside of” means “the axial distance of which, measured from the equatorial plane, is shorter than, respectively longer than”.

The radial direction is a direction that intersects the axis of rotation of the tire and is perpendicular thereto. A radial distance is measured along the radial direction. The expression “radially inside of, respectively radially outside of” means “the radial distance of which, measured from the axis of rotation of the tire, is shorter than, respectively longer than”.

Such tires also usually have, at the beads, one or more layers of reinforcing elements referred to as stiffeners. These layers usually consist of reinforcing elements oriented relative to the circumferential direction at an angle of less than 45°, and usually less than 25°. These layers of reinforcing elements in particular have the role of limiting the longitudinal displacements of the constituent materials of the bead relative to the rim of the wheel in order to limit premature wear of the bead. They also make it possible to limit the permanent deformation of the bead on the rim flange, due to the phenomenon of dynamic flow of the elastomer materials. This deformation of the bead may prevent the retreading of the tires when it is excessive. They also contribute to the protection of the low regions of the tire against the stresses experienced during fitting and removal of the tires on/from the rims.

Furthermore, in the case of anchoring the carcass reinforcement around a bead wire, which consists in at least partly winding the carcass reinforcement around a bead wire in each of the beads forming an upturn that extends higher or lower into the sidewall, the layers of reinforcing elements or stiffener also make it possible to prevent or delay the unwinding of the carcass reinforcement during accidental and excessive temperature rises of the rim.

These layers of reinforcing elements or stiffeners are usually positioned axially on the outside of the upturn of the carcass reinforcement and extend to a height in the sidewall greater than that of the upturn in particular in order to cover the free ends of the reinforcing elements of the upturn.

Although the tires are not designed for these cases, sometimes, in certain countries, certain tires are used outside of the normal conditions in particular in terms of loads carried and inflation pressure. The presence of layers of reinforcing elements or stiffeners also makes it possible to improve the resistance of the tires to such stresses. Indeed, it appears that the stiffener will protect the carcass reinforcement in the bead region of the tire against these stresses corresponding to excessive usages and excessive temperature rises in the region of the beads. However, this protection is not achieved without risk of damaging the stiffener; observed in particular during such usages is damage, via cracking, of the polymer compounds surrounding the radially outer end of the stiffener.

In order to prevent greater degradations of the bead region and in particular crack propagation in the direction of the upturn of the carcass reinforcement, it is customary to offset the ends of the upturn of the carcass reinforcement and of the stiffener in the radial direction.

### SUMMARY OF THE INVENTION AND ADVANTAGES

The inventors thus set themselves the task of providing tires for heavy vehicles of “heavy duty” type, the endurance performances of which are further improved during, in particular, an excessive usage in terms of loads carried and inflation pressure detrimental to the constituent elastomer compounds of the tire, in particular in the regions of the beads of the tire.

This objective has been achieved according to the disclosure by a tire having a radial carcass reinforcement, consisting of at least one layer of reinforcing elements, the tire comprising a crown reinforcement, which is itself covered radially with a tread, the tread being joined to two beads via two sidewalls, the at least one layer of reinforcing elements of the carcass reinforcement being anchored in each of the beads by an upturn around a bead wire, the carcass reinforcement upturn being reinforced by at least one layer of reinforcing elements or stiffener, the relative density of sulfur bridges measured according to the equilibrium swelling method being less than 5% in at least 30% of the elastomer compounds present in the surface of at least one zone Z in a meridian plane, the at least one zone Z being defined in a meridian plane by the combination of two ovals O1, O2:
a first oval O1 consisting, on the one hand, in its radially innermost portion, of a semi-ellipse E1, centered on the end R of the upturn of the at least one carcass reinforcement layer, the major axis of which is tangent to the end R at the upturn of the at least one carcass reinforcement layer, the length of the major axis being equal to 30 mm and the length of the minor axis being equal to 12 mm and, on the other hand, in its radially outermost portion, of a semicircle C1, of diameter D1 equal to 12 mm, centered on the end R of the upturn of the at least one carcass reinforcement layer,
a second oval O2 consisting, on the one hand, in its radially innermost portion, of a semi-ellipse E2, centered on the outermost end T of the at least one layer of reinforcing elements or stiffener, the major axis of which is tangent to the end T at the at least one layer of reinforcing elements or stiffener, the length of the major axis being equal to 30 mm and the length of the minor axis being equal to 12 mm and, on the other hand, in its radially outermost portion, of a semicircle C2, of diameter D2 equal to 12 mm, centered on the outermost end T of the at least one layer of reinforcing elements or stiffener, and
   the elastomer compounds present in the surface of the at least one zone Z in a meridian plane being compositions based on at least one diene elastomer selected from the group of diene elastomers consisting of polybutadienes (abbreviated to “BRs”), synthetic polyisoprenes (IRs), natural rubber (NR), isoprene copolymers, butadiene copolymers with the exception of butadiene-nitrile copolymers (NBRs), apart from diene elastomers bearing carboxyl functions, and mixtures of these diene elastomers.

Within the meaning of the disclosure, the diene elastomer of the composition in accordance with the disclosure is selected from the group of diene elastomers consisting of polybutadienes (abbreviated to “BRs”), synthetic polyisoprenes (IRs), natural rubber (NR), isoprene copolymers, butadiene copolymers with the exception of butadiene-nitrile copolymers (NBRs), and mixtures of these elastomers. Such copolymers are preferentially selected from the group consisting of butadiene-stirene copolymers (SBRs), isoprene-butadiene copolymers (BIRs), isoprene-stirene copolymers (SIRs) and isoprene-butadiene-stirene copolymers (SBIRs). Diene elastomers are understood to mean modified or unmodified diene elastomers. If they are modified, they may be coupled and/or star branched or else functionalized, at the chain end or along the chain with the exception of the elastomers bearing carboxyl functions.

Within the meaning of the disclosure, the relative density of sulfur bridges is the density of sulfur bridges measured according to the equilibrium swelling method relative to the overall density of crosslinking bridges measured according to the equilibrium swelling method.

Within the meaning of the disclosure, the carcass reinforcement may comprise several layers of reinforcing elements, the ends of which are turned up around a bead wire, the ends of the various layers then advantageously being radially offset. The carcass reinforcement may also comprise at least one layer of reinforcing elements, axially outside of the first carcass reinforcement layer anchored in each of the beads by an upturn around a bead wire, extending from one bead to the other and the ends of which are axially outside of the axially innermost point of the bead wire in each bead.

Preferably, according to the disclosure, the at least one layer of reinforcing elements or stiffener consists of reinforcing elements oriented relative to the circumferential direction at an angle of less than 45°, and more preferably less than 25°.

These layers of reinforcing elements or stiffeners are advantageously positioned axially on the outside of the upturn of the carcass reinforcement and extend to a height in the sidewall greater than that of the upturn in particular in order to cover the free ends of the reinforcing elements of the upturn. The at least one layer of reinforcing elements or stiffener may be turned up around the bead wire or engaged in the bead wire, the radially inner end of the at least one layer of reinforcing elements or stiffener then advantageously being radially inside of the point of the bead wire radially closest to the axis of rotation.

Advantageously according to the disclosure, when the tire comprises several layers of reinforcing elements or stiffeners, the point T is advantageously the radially outermost end of the reinforcing layers or stiffeners.

More advantageously, when the tire comprises several layers of reinforcing elements forming the carcass reinforcement that are turned up around a bead wire, the end R is defined by the end of the upturn closest to the point T.

According to one preferred embodiment of the disclosure, the relative density of sulfur bridges measured according to the equilibrium swelling method is less than 5% in at least 50% of the elastomer compounds present in the surface of the at least one zone Z in a meridian plane.

Advantageously according to the disclosure, the point R forming the end of the upturn of the at least one carcass reinforcement layer in a meridian plane is in contact with or included in the at least 30% of the elastomer compounds present in the surface of the at least one zone Z.

Advantageously also according to the disclosure, the point T forming the radially outermost end of the at least one layer of reinforcing elements or stiffener in a meridian plane is in contact with or included in the at least 30% of the elastomer compounds present in the surface of the at least one zone Z.

According to one preferred embodiment of the disclosure, the radially outer end T of the stiffener is radially outside of the end R of the upturn of the at least one carcass reinforcement layer.

According to one advantageous variant of the disclosure, the relative density of ionic bridges measured according to the equilibrium swelling method is greater than 50% in the at least 30% of the elastomer compounds present in the surface of the at least one zone Z in a meridian plane and preferably in the at least 50% of the elastomer compounds present in the surface of the at least one zone Z in a meridian plane.

Within the meaning of the disclosure, the relative density of ionic bridges is the density of ionic bridges measured according to the equilibrium swelling method relative to the overall density of crosslinking bridges measured according to the equilibrium swelling method.

More preferably, the relative density of ionic bridges measured according to the equilibrium swelling method is greater than 60% in the at least 30% of the elastomer compounds present in the surface of the at least one zone Z in a meridian plane and preferably in the at least 50% of the elastomer compounds present in the surface of the at least one zone Z in a meridian plane.

More preferentially still, the relative density of ionic bridges measured according to the equilibrium swelling method is greater than 70% in the at least 30% of the elastomer compounds present in the surface of the at least one zone Z in a meridian plane and preferably in the at least 50% of the elastomer compounds present in the surface of the at least one zone Z in a meridian plane.

More advantageously according to the disclosure, the relative density of carbon-carbon bridges measured according to the equilibrium swelling method is less than 45% in the at least 30% of the elastomer compounds present in the surface of the at least one zone Z in a meridian plane and preferably in the at least 50% of the elastomer compounds present in the surface of the at least one zone Z in a meridian plane.

Within the meaning of the disclosure, the relative density of carbon-carbon bridges is the density of carbon-carbon bridges measured according to the equilibrium swelling method relative to the overall density of crosslinking bridges measured according to the equilibrium swelling method.

More preferably, the relative density of carbon-carbon bridges measured according to the equilibrium swelling method is less than 35% in the at least 30% of the elastomer compounds present in the surface of the at least one zone Z in a meridian plane and preferably in the at least 50% of the elastomer compounds present in the surface of the at least one zone Z in a meridian plane.

More preferentially still, the relative density of carbon-carbon bridges measured according to the equilibrium swelling method is less than 25% in the at least 30% of the elastomer compounds present in the surface of the at least one zone Z in a meridian plane and preferably in the at least 50% of the elastomer compounds present in the surface of the at least one zone Z in a meridian plane.

According to the disclosure, the measurements of crosslinking densities are carried out using the equilibrium swelling method. In order to measure the crosslinking density, the compounds, prepared in the form of samples, were swollen in toluene for 72 hours. The weight of the samples was measured immediately after having drained off the excess solvent using blotting paper. The swelling of the samples and the absorption of solvent is inversely proportional to the presence, and therefore to the density, of crosslinking bridges.

The samples are then dried under vacuum until a constant weight is reached. From the difference between the two weight values measured, the overall density of crosslinking bridges is deduced.

Use is made of isopropyl mercaptan to selectively attack the polysulfide bridges and of hexanethiol to indiscriminately break the polysulfide and disulfide bridges. The samples are treated for 2 hours with isopropyl mercaptan and 48 hours with hexanethiol at 25° C.

After each of these treatments, a measurement of the density of crosslinking bridges is calculated from the weight measurements on the samples after swelling, as described above.

It is thus possible to determine the percentage of sulfur bridges of the samples with regard to the overall density of crosslinking bridges. This measurement of sulfur bridges is described in particular in the publication “RUBBER CHEMISTRY AND TECHNOLOGY, Vol. 87, No. 1, pp. 21-30 (2014)”.

In order to determine the percentage of ionic bridges, the same samples are subjected to a chemical attack by a treatment in toluene in the presence of chloroacetic acid for 120 hours. Such a treatment is described in the publication “POLYMER COMPOSITES—2011, 1513”.

Once the samples are thus treated, measurements of the density of crosslinking bridges are carried out again by a swelling of the compounds in toluene for 72 hours.

The weight of the samples was measured as above immediately after having drained off the excess solvent using blotting paper, then after drying to constant weight. The carbon-carbon bridges constitute the unattacked residual network.

The percentage of ionic bridges is furthermore deduced therefrom by difference from the values obtained previously.

The tests carried out with tires thus produced in accordance with the disclosure have shown that the tires have improved performances in terms of endurance especially during running that leads to high temperature rises of the elastomer compounds present in the regions of the beads, especially during excessive usage in terms of loads carried and inflation pressure.

The inventors consider that they have been able to demonstrate that the relative density of sulfur bridges of less than 5% in at least one portion of the zone Z, as defined according to the disclosure, makes it possible to reduce the sensitivity of the tires to the effects of ageing in particular due to temperature rises. Specifically, the inventors consider interpreting these results by choices of elastomer compounds in precisely defined zones that impart a better resistance to ageing in particular due to temperature rises.

According to one advantageous embodiment of the disclosure, an elastomer compound having a relative density of sulfur bridges measured according to the equilibrium swelling method of less than 5% is a composition based on at least one diene elastomer, a zinc diacrylate derivative in the form of a zinc salt of formula (I)

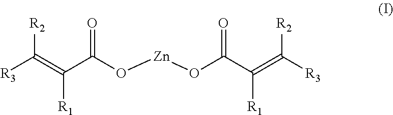

in which R1, R2 and R3 independently represent a hydrogen atom or a C1-C7 hydrocarbon-based group selected from linear, branched or cyclic alkyl groups, aralkyl groups, alkylaryl groups and aryl groups and optionally interrupted by one or more heteroatoms, it being possible for R2 and R3 to together form a nonaromatic ring, the composition additionally comprising a peroxide, the zinc diacrylate derivative and peroxide contents being such that the ratio of the peroxide content to the zinc diacrylate derivative content is less than or equal to 0.09.

More advantageously, the composition comprises no reinforcing filler or comprises less than 65 phr thereof, the ratio of the filler content to the zinc diacrylate derivative content being less than or equal to 4.

The inventors have also demonstrated that the tires produced in accordance with these advantageous embodiments of the disclosure, according to which the content of reinforcing filler is reduced compared to more customary embodiments for the elastomer compounds in question, have improved performances in terms of rolling resistance. Specifically, the presence of elastomer compounds comprising a low filler content results in reduced hysteresis values compared to those of more customary compounds.

Preferentially, the disclosure relates to a composition as defined above in which R1, R2 and R3 independently represent a hydrogen atom or a methyl group. More preferentially, R2 and R3 each represent a hydrogen atom. More preferentially also, R1 represents a methyl group.

Preferably, the disclosure relates to a composition as defined above in which the amount of zinc diacrylate derivative in the composition is within a range extending from 5 to 40 phr (parts by weight per hundred parts by weight of elastomer), preferably from 7 to 35 phr.

Preferentially, the disclosure relates to a composition as defined above in which the peroxide is an organic peroxide, preferentially present in an amount of less than or equal to 3 phr. More preferentially, the amount of peroxide in the composition is within a range extending from 0.1 to 3 phr, more preferentially from 0.2 to 2.5 phr, and more preferentially still from 0.25 to 1.8 phr.

Preferentially, the disclosure relates to a composition as defined above in which the ratio of the peroxide content to the zinc diacrylate derivative content is between 0.01 and 0.09, preferably between 0.03 and 0.09 and more preferentially between 0.05 and 0.08.

It is recalled here that elastomer (or “rubber”, the two terms being regarded as synonymous) of the “diene” type should be understood, in a known way, as meaning an (one or more is understood) elastomer resulting at least in part (i.e., a homopolymer or a copolymer) from diene monomers (monomers bearing two conjugated or non-conjugated carbon-carbon double bonds).

Preferentially, the disclosure relates to a composition as defined above in which the content of reinforcing filler is within a range extending from 5 to 60 phr, more preferentially from 10 to 50 phr, better still from 20 to 40 phr.

Preferably, the disclosure relates to a composition as defined above in which the reinforcing filler is carbon black, silica or a mixture of the latter. Preferentially, the reinforcing filler predominantly consists of carbon black.

Preferentially, the disclosure relates to a composition as defined above in which the ratio of the filler content to the zinc diacrylate derivative content is within a range extending from 0.15 to 3, preferably from 1.5 to 3, alternatively and preferentially also from 0.7 to 1.3.

Preferably, the disclosure relates to a composition as defined above that contains no molecular sulfur or sulfur donor as vulcanization agent or contains less than 0.5 phr thereof. Preferentially, the composition contains no molecular sulfur or sulfur donor as vulcanization agent or contains less than 0.3 phr and preferably less than 0.1 phr thereof. Preferentially, the composition contains no vulcanization accelerator.

Preferentially, the disclosure relates to a composition as defined above that contains no antioxidant.

Preferably also, the disclosure relates to a composition as defined above additionally comprising a plasticizer preferably chosen from plasticizing resins, extender oils and mixtures thereof.

In the present application, the expression “phr” means, in a known manner, parts by weight per hundred parts by weight of elastomer. The amount by weight of the constituents of the compositions is thus expressed relative to the total amount of elastomers by weight which is considered by convention to be the value one hundred.

The expression “composition based on” should be understood as meaning a composition comprising the mixture and/or the product of the in situ reaction of the various base constituents used, some of these constituents being able to react and/or being intended to react with one another, at least partially, during the various phases of manufacture of the composition or during the subsequent curing, modifying the composition as it is prepared at the start. Thus, the compositions as employed for the disclosure can be different in the non-crosslinked state and in the crosslinked state.

In the present description, unless expressly indicated otherwise, all the percentages (%) shown are percentages by weight. Furthermore, any range of values denoted by the expression “between a and b” represents the range of values extending from more than a to less than b (that is to say, limits a and b excluded), whereas any range of values denoted by the expression “from a to b” means the range of values extending from a up to b (that is to say, including the strict limits a and b).

According to one preferred embodiment of the disclosure, the end R of the upturn of the at least one carcass reinforcement layer being separated from the radially outermost end T of the at least one layer of reinforcing elements or stiffener by a layer W of elastomer compound, at least one portion of the layer W of elastomer compound forms at least one portion of the at least 30% of the elastomer compounds present in the surface of the at least one zone Z in which the relative density of sulfur bridges measured according to the equilibrium swelling method is less than 5%.

More preferably according to the disclosure, the at least one layer constituting the carcass reinforcement being formed of reinforcing elements inserted between two elastomer compound calendering layers, at least one portion of the calendering layers of the at least one layer constituting the carcass reinforcement forms at least one portion of the at least 30% of the elastomer compounds present in the surface of the at least one zone Z in which the relative density of sulfur bridges measured according to the equilibrium swelling method is less than 5%.

More advantageously, the at least one layer of reinforcing elements or stiffener being formed of reinforcing elements inserted between two elastomer compound calendering layers, at least one portion of the calendering layers of the at least one layer of reinforcing elements or stiffener forms at least one portion of the at least 30% of the elastomer compounds present in the surface of the at least one zone Z in which the relative density of sulfur bridges measured according to the equilibrium swelling method is less than 5%.

More advantageously, the upturn of the carcass reinforcement being separated from the carcass reinforcement by a layer Y of elastomer compound positioned radially on the outside of the bead wire, at least one portion of the layer Y of elastomer compound forms at least one portion of the at least 30% of the elastomer compounds present in the surface of the at least one zone Z in which the relative density of sulfur bridges measured according to the equilibrium swelling method is less than 5%.

According to one embodiment of the disclosure, the crown reinforcement of the tire is formed of at least two working crown layers of inextensible reinforcing elements that are crossed from one layer to the other, forming angles of between 10° and 45° with the circumferential direction.

According to other embodiments of the disclosure, the crown reinforcement also comprises at least one layer of circumferential reinforcing elements.

One embodiment of the disclosure also provides for the crown reinforcement to be supplemented radially on the outside by at least one additional layer, referred to as a protective layer, of reinforcing elements, referred to as elastic reinforcing elements, that are oriented with respect to the circumferential direction at an angle of between 10° and 45° and in the same direction as the angle formed by the inextensible elements of the working layer which is radially adjacent thereto.

According to any one of the embodiments of the disclosure mentioned above, the crown reinforcement may also be supplemented, radially on the inside between the carcass reinforcement and the radially inner working layer closest to the carcass reinforcement, by a triangulation layer of metal inextensible reinforcing elements that are made of steel and form, with the circumferential direction, an angle of more than 60° and in the same direction as the angle formed by the reinforcing elements of the layer radially closest to the carcass reinforcement.

### BRIEF DESCRIPTION OF THE DRAWINGS

Other details and advantageous features of the disclosure will become apparent hereinafter from the description of exemplary embodiments of the disclosure, with reference to FIGS. 1 and 2, in which:

FIG. 1 depicts a meridian view of a diagram of a tire according to one embodiment of the disclosure,

FIG. 2 depicts an enlarged schematic representation of the bead region of the tire from FIG. 1.

In order to make them easier to understand, the figures are not shown to scale.

### DETAILED DESCRIPTION OF THE ENABLING EMBODIMENT

In the figure, the tire 1, of size 295/80 R 22.5, comprises a radial carcass reinforcement 2 anchored in two beads 3 around bead wires 4. The carcass reinforcement 2 is formed of a single layer of metal cords. The carcass reinforcement 2 is hooped by a crown reinforcement 5, itself capped by a tread 6.

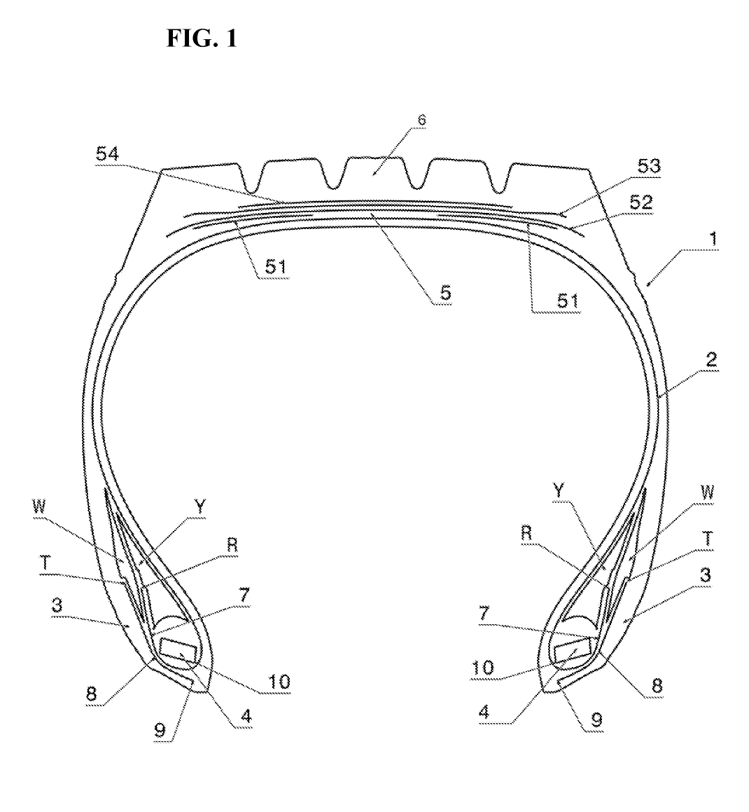

In FIG. 1, the crown reinforcement 5 is formed radially from the inside to the outside:
of a triangulation layer 51 formed of non-wrapped 9.28 inextensible metal cords, oriented at an angle equal to 65°,
of a first working layer 52 formed of non-wrapped 11.35 inextensible metal cords, which are continuous over the entire width of the ply, and oriented at an angle equal to 26°,
of a second working layer 53 formed of non-wrapped 11.35 inextensible metal cords, which are continuous over the entire width of the ply, oriented at an angle equal to 18°, and crossed with the metal cords of the first working layer,
of a protective layer 54 formed of non-wrapped 6.35 elastic metal cords which are continuous over the entire width of the ply and oriented at an angle equal to 18° in the same direction as the metal cords of the working layer 53.

The carcass reinforcement layer 2 is wound around a bead wire 4 in order to form an upturn 7. The upturn 7 is further reinforced by a layer of reinforcing elements or stiffener 8 which covers the end R of the upturn 7 and the radially inner end 9 of which is engaged underneath the bead wire 4.

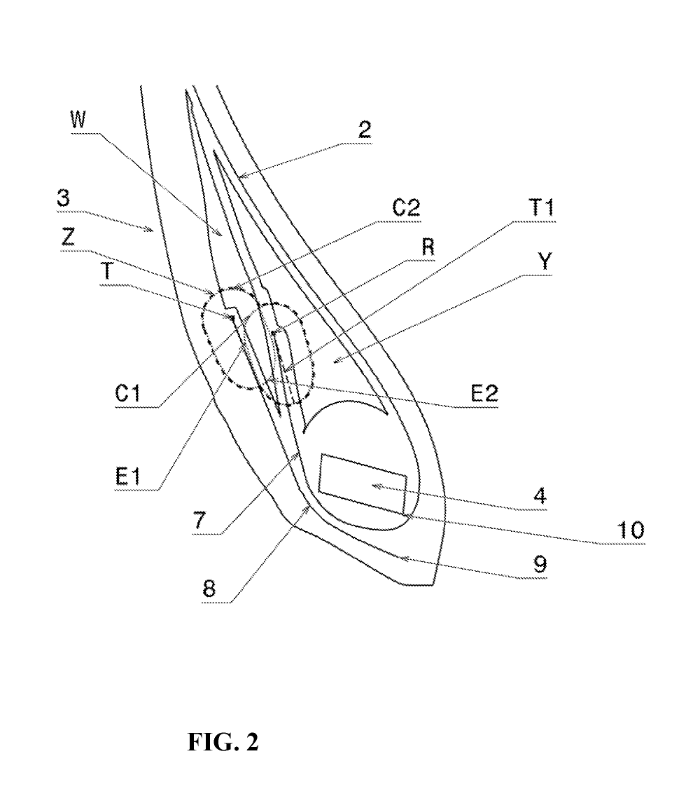

This engagement of the stiffener underneath the bead wire 4 results in a radially inner end 9 of the stiffener radially inside of the point 10 of the bead wire radially closest to the axis of rotation, as illustrated in FIG. 2.

FIG. 2 illustrates, in greater detail, a schematic cross-sectional representation of a bead 3 of the tire in which a portion of the carcass reinforcement layer 2 is found wound around a bead wire 4 in order to form an upturn 7, the end R of which is covered by the stiffener 8.

The radially outer end T of the stiffener 8 is thus radially outside of the end R of the upturn 7 of the carcass reinforcement and the radially inner end 9 of the stiffener 8 is engaged underneath the bead wire 4.

The end R of the upturn 7 of the carcass reinforcement is separated from the stiffener 8 by a layer of elastomer compound W.

An elastomer compound Y radially outside of the bead wire 4 separates the upturn 7 from the carcass reinforcement layer 2.

A zone Z is defined in accordance with the disclosure by the combination of two ovals O1 and O2 in the meridian plane of the figure:
a first oval O1 consisting, on the one hand, in its radially innermost portion, of a semi-ellipse E1, centred on the end R of the upturn of the at least one carcass reinforcement layer, the major axis of which is tangent along T1 to the end R at the upturn of the at least one carcass reinforcement layer, the length of the major axis being equal to 30 mm and the length of the minor axis being equal to 12 mm and, on the other hand, in its radially outermost portion, of a semicircle C1, of diameter D1 equal to 12 mm, centered on the end R of the upturn of the at least one carcass reinforcement layer,
a second oval O2 consisting, on the one hand, in its radially innermost portion, of a semi-ellipse E2, centered on the outermost end T of the at least one layer of reinforcing elements or stiffener, the major axis of which is tangent to the end T at the at least one layer of reinforcing elements or stiffener, the length of the major axis being equal to 30 mm and the length of the minor axis being equal to 12 mm and, on the other hand, in its radially outermost portion, of a semicircle C2, of diameter D2 equal to 12 mm, centered on the outermost end T of the at least one layer of reinforcing elements or stiffener.

Various tires were produced in accordance with the disclosure with a percentage of the zone Z comprising a relative density of sulfur bridges measured according to the equilibrium swelling method of less than 5% varying between 30% and 80%, specific compositions being variably used for the calendering of the carcass reinforcement, the calenderings of the stiffener and also for the W and Y compound layers.

The composition used to produce the calendering layers of the carcass reinforcement layer and the calendering layers of the stiffeners and that makes it possible to obtain a relative density of sulfur bridges measured according to the equilibrium swelling method of less than 5% is the following:

| | |
|---|---|
| NR (1) | 100 |
| ZDA derivative (2) | 20 |
| Peroxide (3) | 1.5 |
| Peroxide/ZDA derivative | 0.075 |
| Filler (4) | 20 |
| Filler/ZDA derivative | 1 |
| ZnO (5) | 6 |

The composition used to produce the layers W and Y and that makes it possible to obtain a relative density of sulfur bridges measured according to the equilibrium swelling method of less than 5% is the following:

| | |
|---|---|
| NR (1) | 100 |
| ZDA derivative (2) | 20 |
| Peroxide (3) | 1.5 |
| Peroxide/ZDA derivative | 0.075 |
| Filler (4) | 40 |
| Filler/ZDA derivative | 2 |
| ZnO (5) | 6 |

(1) Natural rubber
(2) “DIMALINK 634” zinc dimethacrylate (ZDMA) from CRAY VALLEY
(3) “Dicup” dicumyl peroxide from Hercules
(4) N326 ASTM grade carbon black (Cabot)
(5) Zinc oxide (industrial grade—Umicore)

The compositions described above result in a relative density of ionic bridges of the order of 80% and a relative density of carbon/carbon bridges of the order of 20%.

It turns out that the kinematics of curing the rubber compounds having a relative density of sulfur bridges measured according to the equilibrium swelling method of less than 5% are different from the more customary compounds in tire manufacture. In order to facilitate the curing of the various compounds, the inventors applied methods similar to those of retreading operations in order to allow a curing of the tread independent of the curing of the other compounds. The curing of the various zones of the tire may thus be controlled.

A first tire P1 according to the disclosure comprises a layer W, at least the portion of the calenderings of the carcass reinforcement layer present in the surface of the zone Z and at least the portion of the calenderings of the stiffener present in the surface of the zone Z, the rubber compounds of which are produced with the composition described above. The surface occupied by these compounds represents 50% of the surface of the zone Z.

A second tire P2 according to the disclosure comprises a layer W, at least the portion of the calenderings of the carcass reinforcement layer present in the surface of the zone Z and at least the portion of the calenderings of the stiffener present in the surface of the zone Z and the layer Y, the rubber compounds of which are produced with the composition described above. The surface occupied by these compounds represents 80% of the surface of the zone Z.

A tire P3, not in accordance with the disclosure, comprises only at least the portion of the calenderings of the carcass reinforcement layer present in the surface of the zone Z and at least the portion of the calenderings of the stiffener present in the surface of the zone Z. The surface occupied by these compounds represents 20% of the surface of the zone Z.

A reference tire R is produced, comprising no rubber compound in the zone Z having a relative density of sulfur bridges measured according to the equilibrium swelling method of less than 5%.

Running tests were carried out with these four tires to evaluate the performances thereof in terms of endurance.

These endurance tests were carried out on an 8.5 meter development external rolling road test machine, by imposing on the tires deflections of 25% to 35% for running speeds of 60 to 20 km/h.

Before carrying out the tests, the tires undergo an accelerated ageing in an oven under inflation gas oxygen content conditions and temperature conditions that are suitable for producing a state of thermal oxidation of the materials representative of average usage during a customer service life.

The tests carried out result, for the reference tires, in performances that establish the base 100. The tests are stopped on appearance of a degradation of the low region of the tire.

| | R | P1 | P2 | P3 |
|---|---|---|---|---|
| km | 100 | 120 | 130 | 100 |

These results confirm the increases in endurance obtained with elastomer compounds defined and located in accordance with the disclosure in the zone Z.

1. A tire having a radial carcass reinforcement, which includes at least one layer of reinforcing elements, said tire comprising a crown reinforcement, which is itself covered radially with a tread, said tread being joined to two beads via two sidewalls, said at least one layer of reinforcing elements of the carcass reinforcement being anchored in each of the beads by an upturn around a bead wire, said carcass reinforcement upturn being reinforced by at least one layer of reinforcing elements or stiffener, wherein the relative density of sulfur bridges measured according to the equilibrium swelling method is less than 5% in at least 30% of the elastomer compounds present in the surface of at least one zone Z in a meridian plane, wherein said at least one zone Z is defined in a meridian plane by the combination of two ovals O1, O2:
a first oval O1 consisting, on the one hand, in its radially innermost portion, of a semi-ellipse E1, centered on the end R of the upturn of said at least one carcass reinforcement layer, the major axis of which is tangent to the end R at the upturn of said at least one carcass reinforcement layer, the length of the major axis being equal to 30 mm and the length of the minor axis being equal to 12 mm and, on the other hand, in its radially outermost portion, of a semicircle C1, of diameter D1 equal to 12 mm, centered on the end R of the upturn of said at least one carcass reinforcement layer,
a second oval O2 consisting, on the one hand, in its radially innermost portion, of a semi-ellipse E2, centered on the outermost end T of said at least one layer of reinforcing elements or stiffener, the major axis of which is tangent to the end T at said at least one layer of reinforcing elements or stiffener, the length of the major axis being equal to 30 mm and the length of the minor axis being equal to 12 mm and, on the other hand, in its radially outermost portion, of a semicircle C2, of diameter D2 equal to 12 mm, centered on the outermost end T of said at least one layer of reinforcing elements or stiffener, and
wherein said elastomer compounds present in the surface of said at least one zone Z in a meridian plane are compositions based on at least one diene elastomer selected from the group of diene elastomers consisting of polybutadienes (abbreviated to “BRs”), synthetic polyisoprenes (IRs), natural rubber (NR), isoprene copolymers, butadiene copolymers with the exception of butadiene-nitrile copolymers (NBRs), apart from diene elastomers bearing carboxyl functions, and mixtures of these diene elastomers.

2. The tire according to claim 1, wherein the relative density of sulfur bridges measured according to the equilibrium swelling method is less than 5% in at least 50% of the elastomer compounds present in the surface of said at least one zone Z in a meridian plane.

3. The tire according to claim 1, wherein said elastomer compounds present in the surface of said at least one zone Z in a meridian plane are compositions based on at least one diene elastomer, a zinc diacrylate derivative in the form of a zinc salt of formula (I) 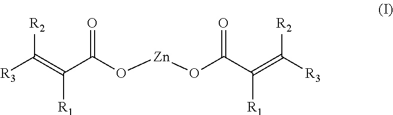
in which R1, R2 and R3 independently represent a hydrogen atom or a C1-C7 hydrocarbon-based group selected from linear, branched or cyclic alkyl groups, aralkyl groups, alkylaryl groups and aryl groups and optionally interrupted by one or more heteroatoms, it being possible for R2 and R3 to together form a nonaromatic ring, said compositions additionally comprising a peroxide, the zinc diacrylate derivative and peroxide contents being such that the ratio of the peroxide content to the zinc diacrylate derivative content is less than or equal to 0.09.

4. The tire according to claim 3, wherein the peroxide is an organic peroxide, preferentially present in an amount of less than or equal to 3 phr.

5. The tire according to claim 3, wherein the ratio of the peroxide content to the zinc diacrylate derivative content is between 0.01 and 0.09.

6. The tire according to claim 1, wherein, in a meridian plane, the point R forming the end of the upturn of said at least one carcass reinforcement layer is in contact with or included in said at least 30% of the elastomer compounds present in the surface of said at least one zone Z.

7. The tire according to claim 1, wherein, in a meridian plane, the point T forming the radially outermost end of said at least one layer of reinforcing elements or stiffener is in contact with or included in said at least 30% of the elastomer compounds present in the surface of said at least one zone Z.

8. The tire according to claim 1, wherein the relative density of ionic bridges measured according to the equilibrium swelling method is greater than 50% in said at least 30% of the elastomer compounds present in the surface of said at least one zone Z in a meridian plane and preferably in said at least 50% of the elastomer compounds present in the surface of said at least one zone Z in a meridian plane.

9. The tire according to claim 1, wherein the relative density of carbon-carbon bridges measured according to the equilibrium swelling method is less than 45% in said at least 30% of the elastomer compounds present in the surface of said at least one zone Z in a meridian plane and preferably in said at least 50% of the elastomer compounds present in the surface of said at least one zone Z in a meridian plane.

10. The tire according to claim 1, the end R of the upturn of said at least one carcass reinforcement layer being separated from the radially outermost end T of said at least one layer of reinforcing elements or stiffener by a layer W of elastomer compound, wherein at least one portion of said layer W of elastomer compound forms at least one portion of said at least 30% of the elastomer compounds present in the surface of said at least one zone Z.

11. The tire according to claim 1, said at least one layer constituting the carcass reinforcement being formed of reinforcing elements inserted between two elastomer compound calendering layers, wherein at least one portion of the calendering layers of said at least one layer constituting the carcass reinforcement forms at least one portion of said at least 30% of the elastomer compounds present in the surface of said at least one zone Z.

12. The tire according to claim 1, said at least one layer of reinforcing elements or stiffener being formed of reinforcing elements inserted between two elastomer compound calendering layers, wherein at least one portion of the calendering layers of said at least one layer of reinforcing elements or stiffener forms at least one portion of said at least 30% of the elastomer compounds present in the surface of said at least one zone Z.

13. The tire according to claim 1, the upturn of the carcass reinforcement being separated from the carcass reinforcement by a layer Y of elastomer compound positioned radially on the outside of the bead wire, wherein at least one portion of said layer Y of elastomer compound forms at least one portion of said at least 30% of the elastomer compounds present in the surface of said at least one zone Z.

14. The tire according to claim 1, wherein said at least one layer of reinforcing elements or stiffener consists of reinforcing elements oriented relative to the circumferential direction at an angle of less than 45°, and preferably less than 25°.

15. The tire according to claim 1, wherein the radially outer end T of the stiffener is radially outside of the end R of the upturn of said at least one carcass reinforcement layer.

16. The tire according to claim 1, wherein the crown reinforcement of the tire is formed of at least two working crown layers of inextensible reinforcing elements, crossed from one layer to the other, forming angles of between 10° and 45° with the circumferential direction.

17. The tire according to claim 1, wherein the crown reinforcement also comprises at least one layer of circumferential reinforcing elements.

18. The tire according to claim 1, wherein the crown reinforcement is supplemented radially on the outside by at least one additional ply, referred to as a protective ply, of reinforcing elements, referred to as elastic reinforcing elements, that are oriented with respect to the circumferential direction at an angle of between 10° and 45° and in the same direction as the angle formed by the inextensible elements of the working ply which is radially adjacent thereto.

19. The tire according to claim 1, wherein the crown reinforcement also comprises a triangulation layer formed of metal reinforcing elements that form angles of more than 60° with the circumferential direction.
